(19) United States
(12) Patent Application Publication
(10) Pub. No.: US 2011/0162745 A1
(43) Pub. Date: Jul. 7, 2011

(54) APPARATUS AND METHOD FOR ADDING FERTILIZER OR OTHER LIQUIDS TO AN IRRIGATION SYSTEM

(76) Inventors: Glen Grizzle, Murrieta, CA (US); Dave Morton, Sandy, UT (US); Dwight Johnson, (US); Donna J. Johnson, Carlsbad, CA (US)

(21) Appl. No.: 12/983,857

(22) Filed: Jan. 3, 2011

Related U.S. Application Data
(63) Continuation of application No. 12/447,251, filed on May 10, 2010.
(60) Provisional application No. 60/854,952, filed on Oct. 27, 2006.

(51) Int. Cl. B01F 5/04; B23P 19/00

(52) U.S. Cl. 137/896; 29/700

(57) ABSTRACT

Apparatus for adding liquid fertilizer to a water line of a sprinkler system includes a mechanical injector device powered by a paddle wheel turned by water flowing through the water line. As the paddle wheel is turned, liquid fertilizer can be advantageously mixed with the irrigation water or other fluid. The fertilizer reservoir can be positioned on the upper portion of the injector apparatus and can include an inlet connection and a button used to hydraulically prime the system. The fertilizer may be fed into the reservoir via tubing from a separately contained fertilizer source. In some embodiments, an inlet nozzle may increase the inlet velocity of the water, thereby permitting the paddle wheel to operate over a greater flow rate range. The tubing or other conduit can be connected to the fertilizer source container via a quick-connect fitting.

### CROSS-REFERENCE TO RELATED APPLICATIONS

This application is a continuation of co-pending U.S. patent application Ser. No. 12/447,251, filed May 10, 2010, which is a National Stage application under 35 U.S.C. §371 of PCT Application No. PCT/US2007/082716, filed on Oct. 26, 2007 and designating the United States. PCT/US2007/082716, which published in English on May 2, 2008 as WO 2008/052182, claims the priority benefit of U.S. Provisional Application No. 60/854,952, filed Oct. 27, 2006. The contents of U.S. patent application Ser. No. 12/447,251, PCT/US2007/082716 and U.S. Provisional Application No. 60/854,952 are hereby incorporated by reference herein in their entireties.

### BACKGROUND OF THE INVENTION

1. Field of the Invention

Embodiments of the present invention relate to irrigation systems, and in particular, to apparatuses, systems and methods for adding a liquid fertilizer or other fluids to an irrigation pipe.

2. Description of the Related Art

Traditionally, fertilizer has been dispensed for home lawn and gardens by manually spraying the nutrients with a hose end or tank sprayer or by distribution of granulated fertilizer through several types of spreaders. Larger turf areas are often fertilized by blending liquid fertilizer with irrigation water using elaborate fertilizer delivery systems, including electronic or pneumatic injection heads, electronic flow and batch control meters, electrical conductivity (EC) and pH meters and instrumentation and computerized (e.g., part-per-million) injection systems. For residential use, small, non-electronic systems are available that can be mounted directly into sprinkling system water supply lines and operated by water pressure and water flow acting on reciprocating piston or diaphragm mechanisms. However, such systems typically are dirt sensitive, unreliable and/or expensive to manufacture. Systems also exist that include compartments which hold solid fertilizer with water directed over the solid fertilizer to dissolve the solid fertilizer into the water. These systems also tend to be unreliable and/or generally inaccurate in the amount of fertilizer dispensed.

The need remains for relatively inexpensive fertilizer injection systems that accurately and automatically inject fertilizer within an irrigation pipe. See e.g., U.S. Pat. No. 6,997,350, filed Apr. 30, 2004 and issued on Feb. 14, 2006, the entirety of which is hereby incorporated by reference herein.

### SUMMARY OF THE INVENTION

One embodiment of the invention comprises an apparatus for injecting liquid fertilizer into a sprinkler system in order to fertilize lawns and gardens. The apparatus mounts directly in the water line of the sprinkler system, usually an underground water line, and uses a paddle wheel rotated by the water flowing in the water line as it flows through the apparatus to drive a mechanical fertilizer injector device. During operation, water from the sprinkling system flows past the paddle wheel causing it to turn. A nozzle may be used to direct the flowing water against the paddle wheel. The paddle wheel turns a planetary gear set that is connected to an output pinion. The output pinion turns a plunger gear attached to a plunger in a plunger chamber. As the plunger turns, slanted tabs on the plunger turn against similar tabs on a ratchet to move or cam the plunger against a spring force. The moving plunger in the plunger chamber first allows liquid fertilizer to enter the chamber and then moves to force the fertilizer in the chamber to flow through the plunger and into the water flowing in the water line to the sprinklers. In a preferred embodiment of the injector apparatus, the plunger chamber is located below a liquid fertilizer reservoir and the rotation of the plunger gear causes interaction of the slanted tabs on camming surfaces on the plunger gear and the ratchet which causes the plunger to move downwardly in the plunger chamber, allowing gravity flow of fertilizer from the liquid fertilizer reservoir into the plunger chamber. Flow may be through a secondary reservoir between the liquid fertilizer reservoir and the entrance to the plunger chamber. A buoyant check valve ball that floats on the liquid fertilizer in the plunger chamber prevents reverse flow of liquid fertilizer back into the liquid fertilizer reservoir. During the downward movement of the plunger, the buoyant ball drops into the plunger chamber to allow the liquid fertilizer to flow down from the reservoir, filling the space between the ball and the plunger. As the plunger tabs reach the top of the ratchet tabs, the tabs fall off each other. The loss of contact between the two sets of tabs which brings the tabs to a period of non-interaction, allows the spring to force the plunger upwards. The fluid trapped between the plunger and buoyant ball is subjected to pressure by the upwardly moving plunger. The pressure forces a check pin in the plunger downward. The fertilizer flows down around the check pin and through a passage through the plunger to mix with the water flowing through the apparatus to the sprinklers.

In some embodiments, the injector apparatus can be situated within a valve box or some other below or above grade enclosure. In other embodiments, the injector apparatus can be connected at or near a hose bib or another outlet device. For example, in one embodiment, one or more adapters can be used to connect the inlet of the injector apparatus to a hose bib or other fluid source. In other embodiments, one or more adapters can be used to connect the outlet of the injector apparatus to the hose or other conduit that is used to convey the fluid to one or more desired locations. The injector apparatus can be configured so that it is positioned on the ground, above ground, below ground, hanging or in any other position, as required or desired by the user.

The amount of fertilizer released into the water depends on the water flow rate and the fertilizer injection rate. The mix ratio can be controlled by adjusting the size of a nozzle that directs the flowing water against the paddle wheel. The apparatus can advantageously use a fertilizer which includes a combination of traditional chemical fertilizers along with a bio stimulant which promotes microbial action in the soil to increase the utilization of the chemical fertilizer by the vegetation to which the fertilizer is applied.

In some embodiments, an apparatus for injecting a first fluid into a conduit carrying a second fluid comprises an inlet and an outlet. The inlet and outlet are configured to be connected to the conduit. The apparatus further comprises one or more mixing chambers, which is in fluid communication with the inlet and outlet. The apparatus additionally includes a fluid reservoir, which is in one-way fluid communication with the mixing chamber. In one embodiment the fluid reservoir may include a reservoir inlet, a reservoir outlet and a vent member. In one embodiment, the apparatus may include a paddle wheel positioned within the mixing chamber, such that a second fluid flowing through the inlet causes the paddle wheel to rotate, which in turn, causes a volume of the first fluid to enter into the mixing chamber through the reservoir outlet.

In another embodiment, the vent member comprises a button. In yet other embodiments, the apparatus further includes a plunger chamber which is in fluid communication with the reservoir outlet and the mixing chamber, a plunger which is movably disposed within the plunger chamber and a plunger gear configured to rotate when the paddle wheel rotates. In one embodiment, rotation of the plunger gear causes a movement of the plunger in a first direction within the plunger chamber. Such a movement in the first direction allows a volume of the first fluid to enter the plunger chamber from the fluid reservoir. In addition, further rotation of the plunger gear causes a movement of the plunger in a second direction within the plunger chamber that allows the volume of the first fluid within the plunger chamber to flow into the mixing chamber.

In yet another embodiment, the apparatus further includes a nozzle configured to be removably positioned within the inlet. The nozzle comprises a housing comprising a nozzle inlet, a nozzle outlet and a fluid passageway positioned between said nozzle inlet and said nozzle outlet. In one embodiment, a restriction member, which is slidably disposed within the housing, is configured to substantially block the nozzle outlet when oriented in a first position. The nozzle further includes a biasing member that is configured to exert a force on the restriction member in a direction of the first position and an infiltration zone in fluid communication with the mixing zone. In some embodiment, the restriction member is configured to slide within the housing in response to a pressure differential between a fluid pressure in the mixing zone and a fluid pressure within the fluid passageway.

In other embodiments, an inlet nozzle is configured to be positioned within an inlet of a fluid device. The inlet nozzle may include a housing comprising, a restriction member slidably disposed within the housing, a biasing member configured to exert a force on the restriction member in a direction of a first position and an infiltration zone in fluid communication with the interior area of the fluid device. The restriction member may be configured to substantially block the nozzle outlet when oriented in the first position. Further, the nozzle housing can include a nozzle inlet, a nozzle outlet in fluid communication with an interior area of the fluid device and a fluid passageway positioned between the nozzle inlet and the nozzle outlet. In one embodiment, the restriction member is configured to slide within the housing in response to a pressure differential between a fluid pressure in the area of the fluid device and a fluid pressure within the fluid passageway. In another embodiment, the biasing member is a spring. In other embodiments, the inlet nozzle further includes an o-ring, which may be positioned between the fluid passageway and the infiltration zone. Such an o-ring is configured to prevent fluid communication between the fluid passageway and the infiltration zone.

In one embodiment, a coupling for connecting a fluid line to a container comprises a fitting and a container portion. The fitting includes a protrusion member configured to be positioned within the container opening, an engagement member configured to contact a surface of the container and one or more tabs positioned along an outside surface of the protrusion member. The container portion may include an opening configured to receive the protrusion member and at least one recess configured to receive the tabs of the fitting. In some embodiments, insertion of the protrusion member within the container opening creates a substantially leak tight connection between the fitting and the container. In other embodiments, the coupling further includes one or more sealing members positioned between the fitting and the container portion. In other embodiments, the sealing member comprises a gasket. In some embodiments, the container portion comprises a bottle cap. In yet another embodiment, an interior of the container is maintained in a substantially air-tight condition when the coupling is connected to the container.

In other embodiments, the cap of a container may include a sealing member configured to block one or more venting openings of the cap. In one embodiment, the sealing member blocks the venting opening when the liquid contents of the container exert a static pressure on the sealing member when during tilting of the container. In another embodiment, the sealing member is configured to block a venting opening when the internal pressure of the container acts to urge the sealing member against a surface of the cap.

In yet other embodiments, a system for injecting liquid fertilizer and/or other liquids into an irrigation system comprise an injection apparatus, a container configured to contain the liquid fertilizer and/or other liquids and tubing or another conduit in fluid communication with the injector apparatus and the container. In one embodiment, the injection apparatus includes a reservoir which is configured to receive liquid from the container. In another embodiment, the inlet of the injection apparatus includes an inlet nozzle configured to increase the velocity of the incoming irrigation water, especially at low flow rates. In still other embodiments, the container and/or the inlet of the injector apparatus reservoir includes a quick-connect coupling. In other embodiments, the container includes a cap which includes a sealing member along its undersurface. The sealing member is configured to block one or more venting openings in the cap when the container is tilted and/or pressurized. The sealing member may permit air to enter the container when the container is returned to its upright position and/or when the internal pressure of the container is sufficiently dissipated.

### BRIEF DESCRIPTION OF THE DRAWINGS

These and other features, aspects and advantages of the present inventions are described with reference to drawings of certain preferred embodiments, which are intended to illustrate, but not to limit, the present inventions. The drawings include twenty-one (21) figures. It is to be understood that the attached drawings are for the purpose of illustrating concepts of the present inventions and may not be to scale.

FIG. 1 is a perspective view of a fertilizer injector apparatus in accordance with one embodiment;

FIG. 2 is side elevation view of one embodiment of a fertilizer system comprising a liquid fertilizer container in hydraulic communication with the fertilizer injector apparatus, such as the one illustrated in FIG. 1;

FIG. 3 is a perspective view of the fertilizer injector apparatus of FIG. 1 with a portion of the apparatus body removed to reveal its internal components and structure;

FIG. 4 is an exploded perspective view of the injector apparatus of FIG. 1;

FIG. 5 is a bottom perspective view of an upper portion of the injector apparatus of FIG. 1;

FIG. 6 is similar to the bottom perspective view of FIG. 5 with the switch cam in the “OFF” position;

FIG. 7 is a partially exploded perspective view of the injector apparatus of FIG. 1;

FIG. 8 is perspective view of a fertilizer injector apparatus being primed according to one embodiment;

FIG. 9 is side elevation view of a fertilizer injector apparatus positioned within a valve box and in hydraulic communication with a fertilizer container;

FIG. 10 is perspective view of an inlet nozzle according to one embodiment;

FIG. 11A is a cutaway perspective view of a fertilizer injector apparatus with an inlet nozzle positioned in its inlet according to one embodiment;

FIG. 11B is a detailed view of the inlet nozzle of FIG. 11A;

FIG. 12A is cross-sectional side view of the inlet nozzle of FIG. 11A in a first position;

FIG. 12B is cross-sectional side view of the inlet nozzle of FIG. 11A in a second position;

FIG. 13A is a modeled schematic of the flow field of fluid discharged from the inlet nozzle of a fertilizer injector apparatus according to one embodiment;

FIG. 13B is a modeled schematic of the flow field of fluid discharged from the inlet nozzle of a fertilizer injector apparatus as it contacts the internal paddle wheel according to another embodiment;

FIG. 14 is perspective view of a quick-connect fitting configured to connect to a container of liquid fertilizer or other source fluid according to one embodiment;

FIG. 15 is perspective view of a quick-connect fitting being positioned within a corresponding opening of a fertilizer or other liquid container;

FIG. 16A is a perspective view of a cap configured for placement over a container opening according to one embodiment;

FIG. 16B is top view of the cap of FIG. 16A; and

FIG. 16C is a bottom view of the cap of FIG. 16A.

### DETAILED DESCRIPTION OF THE PREFERRED EMBODIMENTS

The embodiments described below and the various systems, features and methods associated with its operation have particular utility in the context of a liquid fertilizer injection device, and thus, are described in the context of such a fertilizer injection device. The apparatus, as well as its various systems and features, however, can be used in other liquid injection and/or mixing devices for irrigation, chemical processing and other industrial applications. For example, liquids such as pesticides, herbicides, fungicides, solid conditioners, rust preventers may be injected into the systems described herein.

Additional details and embodiments of injection apparatuses and systems can be found in U.S. Pat. No. 6,997,350, the entirety of which is hereby incorporated by reference herein.

### Injector Apparatus

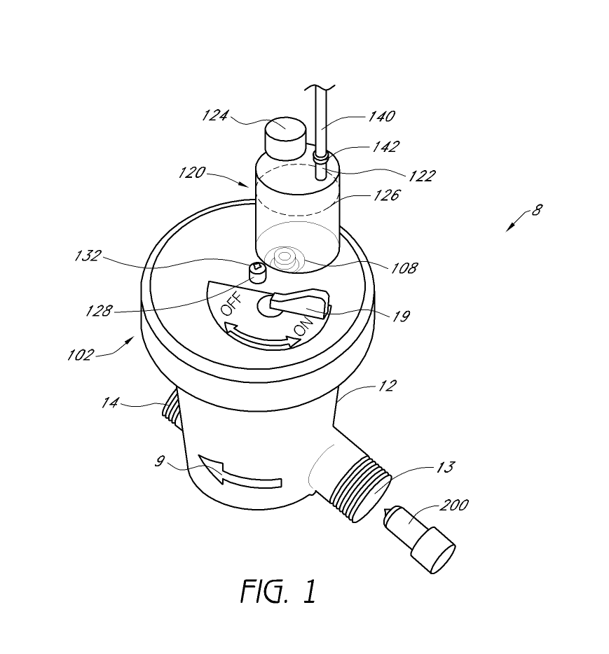

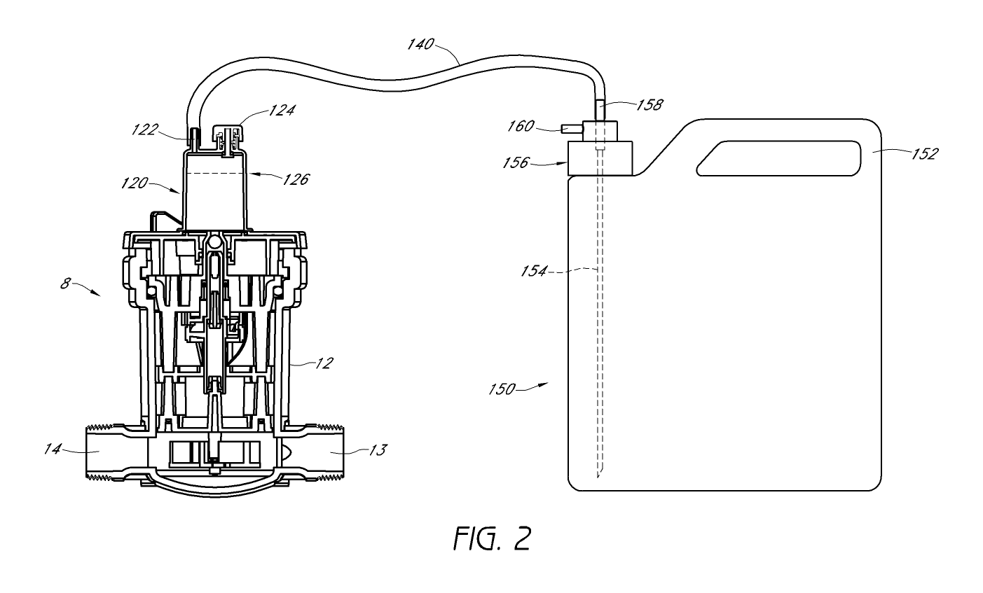

As depicted in FIGS. 1 and 2, the fertilizer injector apparatus 8 includes a liquid fertilizer reservoir 120, within which liquid fertilizer and/or other fluid may be stored, an injector body 12 and a water inlet 13 and water outlet 14 that connect the injector apparatus 8 to a sprinkling system pipe or line (not shown) so that water flowing through the pipe flows through a portion of the injector body 12. The liquid fertilizer reservoir 120, which in the illustrated embodiment is positioned on top of injector body 12, can include a vent button 124 and a reservoir inlet nozzle 122. In some embodiments, the reservoir inlet nozzle 122 is connected to a hose 140 or other fluid conduit.

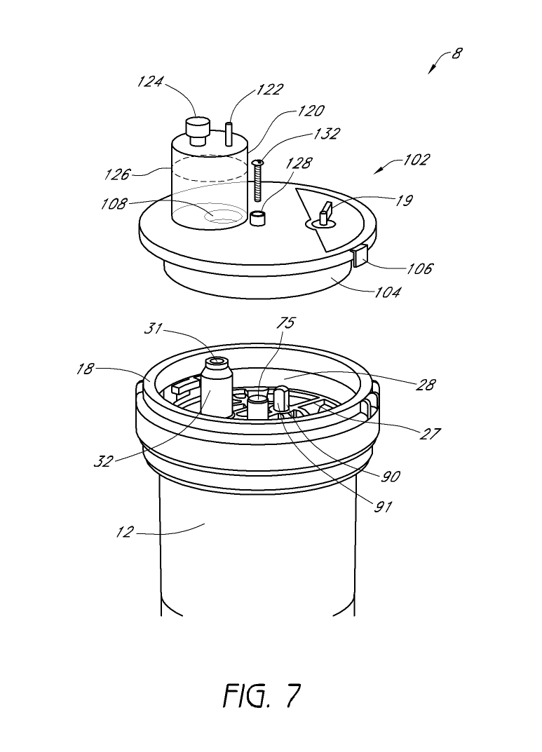

In FIG. 2, the fertilizer or other feed substance is stored in a fertilizer storage container 150. Further, the top of the injector apparatus 8 can include an ON-OFF knob 19 that controls whether the fertilizer and/or other feeder substance stored within the liquid fertilizer reservoir 120 is fed into the water pipe. As illustrated in FIGS. 1 and 7, an upper portion 102 of the injector apparatus 8 can be secured to an adjacent lower portion using one or more clips 106 and/or screws 132. It will be appreciated that other methods of connecting the upper and lower portions to one another may be used, either in lieu of or in addition to the clips 106 and/or screws 132. For example, the upper portion 102 may be connected to the lower portion of the injector apparatus 8 using one or more snap fit, press-fit, adhesive, threaded, latching and/or other type of attachment methods or devices.

In some embodiments, once the system is primed, as described below, liquid fertilizer can be configured to flow from the storage container 150 through tubing 140 or another conduit into the liquid fertilizer reservoir 120. As discussed, the fertilizer may then be drawn into a plunger chamber 32 of the injector body 12 through a bottom opening 108 in the reservoir 120. In a primed system, fertilizer may be transferred from the storage container 150 to maintain a substantially constant volume of fertilizer in the reservoir 120. For example, in some embodiments, the volume of liquid fertilizer within the reservoir is maintained at a target level indicated by a fill line 126. Additional details regarding the liquid fertilizer reservoir 120, the priming system and the like are discussed in greater herein.

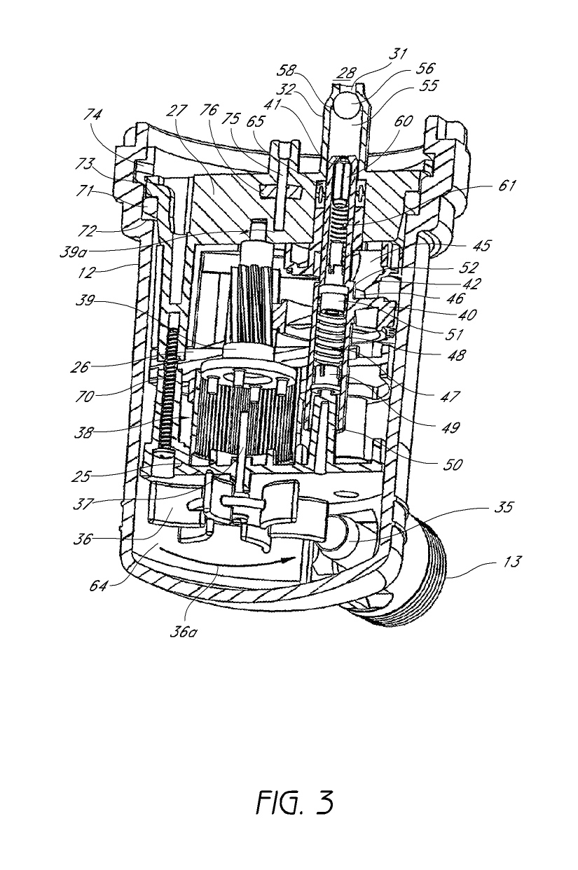

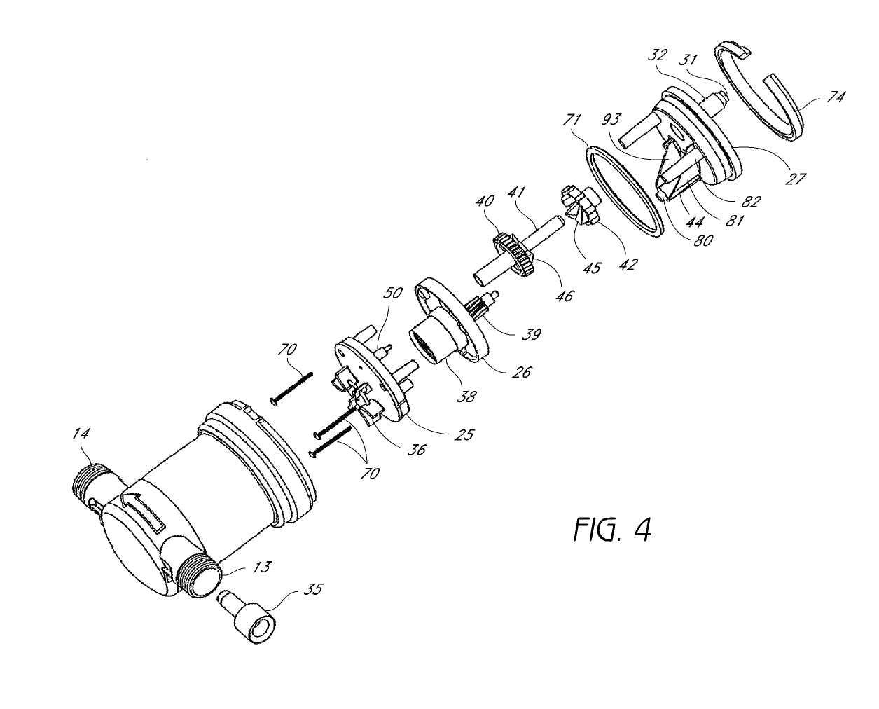

As illustrated in FIGS. 3 and 4, the injector apparatus body 12 can be configured to hold and position a lower plate 25, an intermediate plate 26, and a bulkhead 27, which mount the operating parts of the injector apparatus. A secondary reservoir 28, can be formed between the bottom of reservoir 120 and the top of bulkhead 27 over injector apparatus body 12. In some embodiments, liquid fertilizer flows through the reservoir bottom opening 108 (FIG. 7) into the secondary reservoir 28. The bottom opening 108 can include a strainer screen (not shown) to filter out any debris present in the liquid fertilizer. Liquid fertilizer can enter a mechanical injection device of the injector apparatus through an inlet 31 in the top of a plunger chamber 32. The reservoir bottom opening 108 may be offset from the plunger chamber inlet 31 in order to increase the likelihood that any debris that passes through screen 30 settles in the top area of the bulkhead at a level below the height of the injector plunger chamber inlet 31. This can help ensure that such debris does not pass through the inlet 31 to the plunger chamber.

According to some embodiments, the mechanical injector device 8 is powered by water flowing through the sprinkler water flow line into the water inlet 13 in the bottom portion of injector apparatus body 12, through a nozzle 35 (see FIGS. 3 and 4), and across a paddle wheel 36. Flowing water can cause rotation of the paddle wheel 36, here shown to be in a clockwise direction looking downwardly (generally represented by arrow 36a), which, in turn, may cause liquid fertilizer from the reservoir 10 that flows through a secondary reservoir 28 and into plunger chamber inlet 31 to be injected into the water from the sprinkler system water flow line flowing through the apparatus. In some arrangements, the amount of fertilizer injected is proportional to the speed of rotation of the paddle wheel, which, in turn, depends upon the flow rate of the water through the apparatus. Different nozzle sizes can be used to alter the water velocity acting against the paddle wheel at a given flow rate. This can change the rotation rate of the paddle wheel. As discussed in greater herein, a dynamic inlet nozzle can be used to increase the flow rate over which the paddle wheel operates.

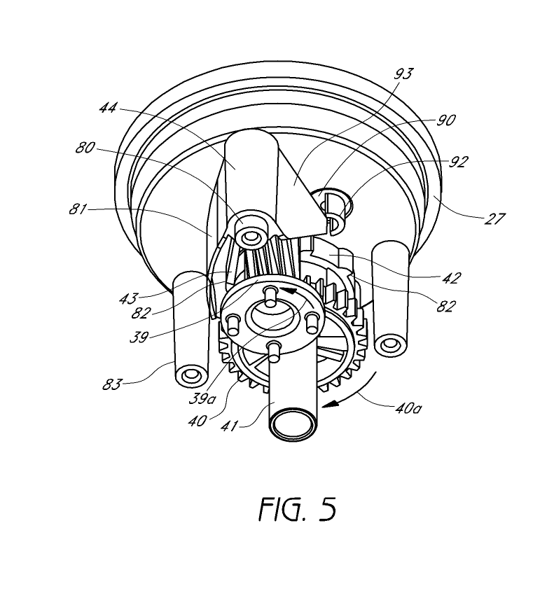

With continued reference to the embodiment illustrated in FIG. 3, the rotating paddle wheel 36, which is mechanically attached to shaft 37, is rotatably held in the lower plate 25. The paddle wheel 36 is configured to turn a planetary gear set 38, which is held by a lower plate 25 and an intermediate plate 26. Thus, in one embodiment, turning of the paddle wheel 36 causes an output pinion 39 to also turn. As shown, the output pinion 39 can extend between, and is rotatably held in position by, the intermediate plate 26 and the bulkhead 27. Further, a planetary gear set 38 can be used to reduce the revolution rate of the connected output pinion 39 in relation to the revolution rate of paddle wheel 36, making the output pinion rotate more slowly than the paddle wheel 36. The revolving output pinion 39 turns the plunger gear 40, which is part of and is and concentric with, the plunger 41. Thus, rotation of the plunger gear 40 causes rotation of the plunger 41. In the depicted embodiment, the gears are arranged so that clockwise rotation of paddle wheel 36 causes counterclockwise rotation of pinion gear 39 (looking downwardly), as indicated by arrow 39a. In turn, this causes clockwise rotation of the plunger gear 40 (as indicated by the arrow 40a in FIG. 5) and the plunger 41.

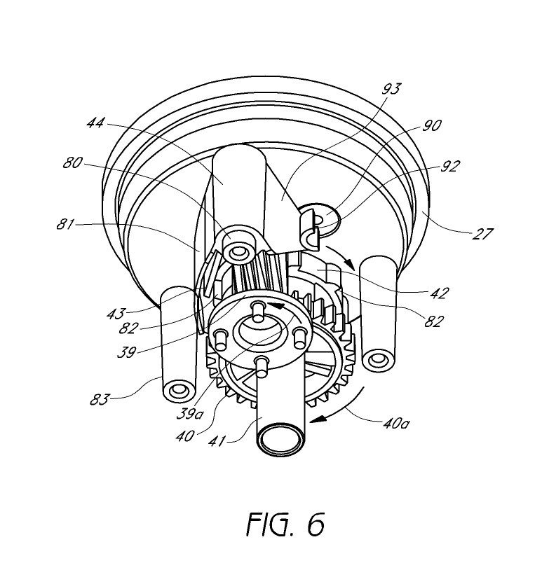

With reference to FIGS. 5 and 6, the plunger gear 40 can be configured to rotate relative to a ratchet 42 that is held generally stationary against the clockwise rotation of plunger gear 40 by a pawl arm 43 of the pawl 44. In one embodiment, the ratchet 42 has slanted ratchet tabs 45 (FIGS. 3 and 4) extending downwardly from the bottom thereof. In some embodiments, the slanted ratchet tabs 45 act as ramps for similarly slanted plunger tabs 46 extending upwardly from plunger gear 40. The confronting camming surfaces of the ratchet tabs 45 and the plunger tabs 46 can push against one another as the plunger gear rotates in relation to the ratchet. Consequently, this can cause the plunger 41 to move downwardly against the bias of a plunger spring 47 within plunger central bore 48. The lower end of plunger spring 47 can be supported by a spring retainer 49 that rotates freely on a post 50 projecting from the lower plate 25. As the plunger 41 rotates, the plunger spring 47 and the spring retainer 49 can be configured to freely rotate with it. As illustrated, a spring guide 51 can engage the top of the plunger spring 47 and the shoulder 52 in the plunger central bore 48 to compress the plunger spring 47 as the plunger 41 moves downwardly.

In some embodiments, the plunger 41 slides within the plunger chamber 32. The plunger chamber 32 can connect through the plunger chamber inlet 31 to the liquid fertilizer secondary reservoir 28 so that liquid fertilizer held in the secondary reservoir 28 flows into a space 55 between the plunger chamber inlet 31 and the top of plunger 41. Further, in some arrangements, a generally buoyant check ball 56 is positioned in a narrowed, conical entrance 58 from the secondary reservoir 28 to space 55 to form a check valve, thereby preventing the reverse flow of liquid fertilizer from the plunger chamber space 55 into the secondary reservoir 28 and reservoir 120. The check ball 56 can comprise one or more materials that float in water and liquid fertilizer, such as, for example plastic or the like. Alternatively, the check ball 56 can be at least partially hollow so that it can float. In some embodiments, as the plunger 41 rotates and moves downwardly in the plunger chamber 32, liquid fertilizer flows by gravity from the secondary reservoir 28 past the check ball 56 into the space 55. Further, as liquid fertilizer fills space 55, the check ball 56 floats and rises against narrow the conical entrance 58. In the illustrated embodiment, liquid fertilizer from the liquid fertilizer reservoir 120 can flow by gravity into the plunger chamber.

As indicated, rotation of the paddle wheel 36 can cause the plunger gear 40 to also rotate. As a result of this rotation, the interaction between the plunger tabs 46 and the ratchet tabs 45 can cause the plunger 41 to move downwardly and allow liquid fertilizer to flow into space 55. The space 55 can be configured to enlarge as the plunger 41 moves downwardly in the plunger chamber 32. In some embodiments, as the plunger tabs 46 reach the top of ratchet tabs 45, continuing rotation of plunger gear 40 causes the plunger tabs to fall off the ratchet tabs. Consequently, the plunger spring 47 urges the plunger 41 upwardly into the plunger chamber 32. Flow of liquid fertilizer from the plunger chamber 32 back into secondary reservoir 28 is blocked by the check ball 56. Thus, the plunger 41 moving upwardly in the plunger chamber 32 can exert pressure on the liquid fertilizer trapped in space 55. In the illustrated arrangement, a check pin 60 in the end of the plunger 41 is held in a normally closed position by a check spring 61. This can close the upper end of plunger central bore 48 that forms a flow passage for the liquid fertilizer through plunger 41. The bottom of the check spring 61 can be supported in the plunger central bore 48 by a spring guide 51, while the top of the check spring 61 can rest against the check pin 60. In one embodiment, the plunger spring 47 is stronger than the check spring 61 to overcome the sealing force of the check spring 61 on the check pin 60 by exerting an upwardly directed pressure on the force plunger 41. This can pressurize the liquid within the space 55 such that it moves the check pin 60 against the bias of the check spring 61, thereby allowing liquid fertilizer to flow from the space 55, around the check pin 60, into the plunger central bore 48, around post projection 50 and onto lower plate 25. From the lower plate 25, the liquid fertilizer or other substance can flow around the circumference of lower plate 25. In one embodiment, the liquid fertilizer then mixes with the water or other fluid as the water or other fluid passing the paddle wheel flows up into this area, or as the fertilizer flows down around the circumference of the lower plate 25 and into the mixing chamber 64 where the paddle wheel 36 is located. Preferably, the check spring 61 has sufficient strength to provide the necessary sealing force to the check pin 60. This can help prevent the liquid fertilizer from being drawn downwardly from the space 55 and the secondary reservoir 28 into the mixing chamber 64 if the sprinkler water flow line is ever subject to a negative pressure. The apparatus can comprise plunger wipes 65 that help keep dirt away from the plunger chamber. The plunger wipes 65 can form a seal for the bottom of the plunger chamber 32 between the bottom of bulkhead 27 and the top of ratchet 42. In some embodiments, as the plunger gear 40 continues to rotate, a period of non-interaction exists between the tab camming surfaces until the tabs again meet and interact to again move the plunger gear and plunger downwardly.

In some embodiments, the plunger and plunger chamber arrangement forms a mechanical injector device. Such a mechanical injector device can be configured to inject liquid fertilizer from the reservoir 10 into the water or other fluid flowing through the sprinkler line and into the mixing chamber of the apparatus. Thus, the various gears, springs, the interacting plunger and ratchet tabs and/or other components can advantageously form a drive so the rotation of the paddle wheel will operate the mechanical injector device.

In some embodiments, the injection apparatus is assembled by placing the various components and parts between the lower plate 25, intermediate plate 26 and bulkhead 27, and securing the plates and bulkhead together by screws 70 extending through the lower and intermediate plates and threaded into the bulkhead. It will be appreciated that the apparatus can be assembled differently than described in this embodiment. For example, one or more other methods or devices for securing the various components to each other may be used, such as other fasteners and the like.

The assembly can then be secured in the injector apparatus body with an o-ring 71 between the injector apparatus body shoulder 72 and the bulkhead shoulder 73 to form a seal. For example, a snap ring 74 or other device can be used to secure these components to each other. The fertilizer reservoir 120 can be positioned on the injector apparatus body 12 and secured in place by one or more screws 132. As shown, the screws 132 and/or other fasteners can be threaded into corresponding holes 75 in the bulkhead 27. A brass nut or other insert 76 may be molded into the bulkhead 27 and aligned with the hole 75 to ensure that the screw 132 can be adequately tightened without stripping the hole 75 in the bulkhead.

In some embodiments, the ratchet and pawl are provided as a convenient way to turn the apparatus “ON” and “OFF”, and/or to prevent damage to the gearing and plunger lift mechanism, such as the ratchet tabs 45 and the plunger tabs 46. This can be especially helpful in the event that the apparatus is connected backwardly and reverse flow is applied to the paddle wheel. In the instance of reverse flow that causes reverse rotation of the paddle wheel 36 and the plunger 41, the ratchet 42 can be configured to merely spin with the rotating plunger. Accordingly, there may be no interaction between the camming surfaces of the tabs, and the plunger will not move down and up as described. The pawl 44 is pivotally mounted on the post 80 extending from bulkhead 27.

In some embodiments, the pawl 44 includes a leaf spring member 81, which in one arrangement comprises a plastic material having spring like properties. Thus, the leaf spring member 81 can generally act against post 83 to provide a preload force or bias to the pawl 44 and the pawl arm 43. With reverse rotation of the ratchet 44, the ratchet teeth 82 can be configured to merely slide under the pawl arm 43 as the pawl arm 43 rotates against the bias created by the spring member 81. However, as shown in FIG. 5, with the proper direction of rotation of the ratchet 44, the pawl arm 43 can engage a ratchet tooth 82 to prevent the ratchet 44 from rotating.

The apparatus 8 can include a knob 19 that permits a user to selectively turn the apparatus “ON” to inject fertilizer into the sprinkler pipe and to turn the apparatus “OFF” to prevent fertilizer from being injected into the sprinkler pipe. Preferably, irrigation water or other fluid can be permitted to flow through the apparatus regardless of whether the knob is the “ON” or “OFF” position. In one embodiment, the selector knob 19 includes a stem 20 (not shown) having a bottom opening configured to receive a post flat. When the upper portion 102 of the apparatus 8 is secured to the lower portion of the apparatus 8, the knob stem can be sized, shaped, positioned and otherwise configured to fit over switch post 90 (FIG. 7). The switch post flat 91 can mate with the knob stem flat so that rotation of knob 19 causes rotation of switch post 90.

With continued reference to the embodiments illustrated in FIGS. 5 and 6, the switch post 90 extends through bulkhead 27 and includes a switch cam 92. The switch cam 92 can interact with the pawl switch arm 93 of the pawl 44. With the knob 19 rotated to the “ON” position, the switch post 90 and switch cam 92 can be in the position illustrated in FIG. 5, and the apparatus 8 can operate to inject liquid fertilizer or other fluid into the irrigation water or other liquid flowing through the apparatus. However, in some embodiments, where the knob 19 rotated to the “OFF” position, the switch post 90 and switch cam 92 are rotated to move the pawl switch arm 93 and the rotate pawl 44 to the position shown in FIG. 6. In such an arrangement, the pawl arm 43 of the pawl 44 may be rotated away from engagement with the ratchet teeth 82. In this position, the ratchet 42 can rotate with the plunger 41 in the forward direction, and the ratchet tabs 45 and the plunger tabs 46 may not move over each other. This can help prevent down and up or a pumping movement of plunger 41. Consequently, the mechanical injection device may be disabled so that no liquid fertilizer is injected into the sprinkler water passing through the apparatus 8. However, as discussed, the paddle wheel can continue to turn so that it does not disrupt the flow of water as it moves through the apparatus.

A wide variety of gear ratios and plunger and nozzle dimensions may be used depending upon the desired or required amount of liquid fertilizer to be added to the water. According to one embodiment, the apparatus comprises a planetary gear set 38 that reduces the revolution of the output pinion 39 at a ratio of 750:1. Consequently, the paddle wheel 36 turns 750 times to turn the output pinion 39 one revolution. In that embodiment, the output pinion 39 includes a ratio of 3:1 with the plunger gear 40. The ratchet 42 can include three ratchet tabs 45 at a 120 degree spacing, resulting in the plunger 41 being forced downwardly against the plunger spring 47 three times for every revolution of the output pinion 39, or three times for every 750 turns of the paddle wheel 36. The valve seats in the top of injection chamber 58 and the top of plunger 41 can be conical in shape to facilitate the rapid purging of air from the injector. This can help ensure that the required displacement volume of the plunger is achieved relatively quickly or substantially immediately after being installed. For example, the diameter of the injector plunger 41 is approximately 0.375 inches. Further, in some embodiments, the injector plunger 41 is configured to include a downward movement of approximately 0.500 inches, thereby yielding a displacement volume of approximately 0.0552 cubic inches. Accordingly, this can provide an injection of approximately 0.02 ounces of fertilizer for each cycle or stroke of the plunger. It will be appreciated that the gear ratios, diameters, displacement volumes and other numerical values and properties of the apparatus and/or its various components can be different that discussed and illustrated herein, as desired or required by a particular application.

For a given flow rate in the sprinkler system line, the diameter of inlet nozzle 35 can be used to control the injection rate of the liquid fertilizer. For example, a smaller nozzle size will result in water contacting the paddle wheel 36 at a relatively high velocity, as higher velocity water will rotate the paddle wheel faster than slower water. Consequently, the volume of liquid fertilizer or other material which is released generally increases with increasing irrigation water velocity. As discussed, this is because the rotational speed of the paddle wheel controls the rate at which the plunger moves, and thus, the rate at which liquid fertilizer is pumped or injected into the sprinkler system. In some embodiments, the rotational speed of the paddle wheel is proportional to the rate of water flow through the inlet and nozzle. However, in other embodiments, the relationship between rotational speed of the paddle wheel and the rate of water flow through the inlet can be non-proportional.

The paddle wheel rotation can be caused by the kinetic energy from the inlet water, accelerated by the nozzle, acting against the blades of the paddle wheel. Further, the speed of the paddle wheel can be retarded by viscous drag of the blades in the water field outside the nozzle plume. In one arrangement, both of these forces can be described by second order functions, resulting is a generally linear relationship between paddle wheel rotational speed (e.g., revolutions per minute, RPM) and the flowrate of water passing through the nozzle. Further, the injector apparatus can extract power from the paddle wheel to inject the fertilizer into the water. The above factors may cause some slippage of the paddle wheel in the water to occur, particularly as the flow through the apparatus decreases. In some embodiments, nozzles having a diameter of about 0.65 or 0.50 inches have been found to have good water flow rates, capable of providing an advantageous proportional relationship from about 40 gallons per minute down to about 2 gallons per minute, and at water pressures between about 10 to 25 pounds per square inch (psi). It will be appreciated that different size nozzles may be provided as desired or required by a user or installer depending upon the particular parameters and needs of the system with which the apparatus is to be used. In some embodiments of the apparatus described and illustrated herein, a 0.65 inch diameter nozzle injects fertilizer at the rate of approximately 1:8000, i.e., one part fertilizer to 8000 parts water. In other embodiments, a 0.50 inch diameter nozzle can inject fertilizer at a rate of approximately 1:6000.

The embodiments described and illustrated herein can use spiral bevel gearing for the output pinion 39 and the plunger gear 40. This can help create an axial bias on the output pinion away from the planetary gear set as the gear train is loaded in order to prevent excessive friction on the planetary gear set due to thrust loading. Further, most parts of the injector apparatus can comprise an acetal plastic material or any other rigid or semi-rigid material. In one embodiment, the plunger, the plunger gear, the injector tabs and the ratchet tabs can comprise an acetal plastic material containing about 15% Teflon and about 5% silicone. This can help make such parts self-lubricating so that the confronting tab camming surfaces can slide more easily relative to one another. Further, this can help the plunger and the plunger gear move vertically (e.g., up and down in relation to the plunger chamber and the pinion gear, respectively) more easily. In addition, the spring guide 51 and spring retainer 49 can include porting to allow rapid transfer of the liquid fertilizer out of the plunger bore when the plunger 41 is released and driven upwards by the plunger spring 47.

According to some embodiments, the injector apparatus body is constructed of a GE Noryl GTX 830 plastic material with about 20% glass fiber added. This can help provide a relatively strong body that will capable of withstanding high internal water pressures. Of course it will be recognized by those of skill in the art that the various components of the apparatus 8 may be constructed of one or more other materials, regardless of whether or not specifically mentioned herein.

As discussed, the apparatus can include a paddle wheel that, through a drive arrangement, moves a plunger to a cocked position in a plunger chamber while the chamber fills with liquid fertilizer. The plunger can be released from its cocked position so that it moves under spring force in the plunger chamber. This can help cause liquid fertilizer to flow through a passage in the plunger to the mixing chamber to mix with the irrigation water or other fluid flowing through the mixing chamber to the sprinklers. Thus, the movement of the plunger in the plunger chamber can inject the liquid fertilizer or other fluid into the water flowing through the apparatus.

A special fertilizer for use with the fertilizer injection apparatus may be used. Such fertilizers can include not only the typical macronutrients (e.g., nitrogen, phosphorus, potassium, etc.), but also one or more bio-stimulants. Bio-stimulants can cause microbial action in the soil to break down the components of the fertilizer applied into more usable forms by the targeted vegetation. Further, this can help breakdown and release other minerals, which may be micronutrients needed by the vegetation. In some embodiments, the bio-stimulant is a mixture of enzymes, complex carbohydrates, proteins, amino acids, micronutrients (i.e., nutrients needed in small amounts by plants, such as boron, iron and zinc) and/or the like. A bio-stimulant can trigger natural biological processes in the soil that convert tied up nutrients into a more soluble form that plants can more readily utilize. The bio-stimulant can also accelerate the break down and conversion of organic matter, such as, for example, crop residue, lawn clippings and the like, into humus, an extremely beneficial source of nutrients for plants. This can be accomplished, for example, by increasing the populations of indigenous microorganisms in the soil. One bio-stimulants includes that available under the name AGRI-GRO® from Agri-Gro Marketing, Inc. (Doniphan, Mo.). The AGRI-GRO® product is derived from culturing and fermenting microbes such as azotobacter, bacillus and clostridium. The use of the bio-stimulant with the conventional fertilizer can improve the effect of using a conventional fertilizer. In addition, as discussed, bio-stimulants can make other micronutrients in the soil available for plant use. Further, fertilizers, such as those used in connection with the various embodiments discussed and illustrated herein, have an acidic nature that helps keep the fertilizer from coagulating or crystallizing. This may cause clogging of the passageways in the apparatus of the invention. Thus, use of such fertilizers can help ensure that the apparatus works satisfactorily.

According to certain preferred formulations, the fertilizer comprises between about 7% to about 18% nitrogen, about 2% to about 20% phosphorus, about 2% to about 13% potassium and about 6% to about 25% bio-stimulant. Of course, it will be appreciated that the formulations can be varied as desired or required by a particular user or application. In some embodiments, the fertilizer can be made by mixing a conventional fertilizer with a bio-stimulant. Thus, for example, a 10-13-13 conventional fertilizer (10% nitrogen, 13% phosphorus and 13% potassium) may be mixed with bio-stimulant so that 15% of the final mixed fertilizer is bio-stimulant. In such a case, the final concentrations in the mixed fertilizer will be 15% bio-stimulant, 8% nitrogen, 10% phosphorus and 10% potassium. In some embodiments of the fertilizer, the nitrogen is at least partially in the form of urea nitrogen, the phosphorus is provided as phosphate or phosphoric acid and the potassium is provided as potash, potassium hydroxide. Different formulations can be utilized, depending on the particular application, use, time of year and/or other factors (e.g., type of area being fertilized, season, etc.).

By way of example, an early season lawn and landscape fertilizer may use an 18-3-3 fertilizer with 18% bio-stimulant added, a midseason lawn and landscape fertilizer may use a 10-13-13-fertilizer with 15% bio-stimulant added and a late season lawn and landscape fertilizer may use an 18-4-4 fertilizer with 6% bio-stimulant added. A garden fertilizer may use a 10-13-13 fertilizer with 25% bio-stimulant added while a bedding plant fertilizer may use a 10-20-10 fertilizer with 18% bio-stimulant added.

In other embodiments, fertilizers having other combinations of nitrogen, phosphorus, potassium, biostimulants and/or other ingredients can be used. In yet other embodiments, the injector apparatus can be used to deliver other types of liquid, such as, for example, pesticides, herbicides, fungicides, rust preventers or the like into the irrigation system or other inlet conduit. Such liquids can be used alone or in combinations with other types of liquids, chemicals, substances or the like.

As described, the injector apparatus can be configured to deliver a fertilizer, feed and/or any other substance to irrigation water or other fluid source. In some embodiments, the fertilizer or other substance can be fed consistently and/or gradually from the reservoir. This process, which is sometimes referred to as “microdosing,” can allow the fertilizer, feed and/or other substance to be fed into the irrigation water or other fluid source over an extended time period. However, in other embodiments, the fertilizer, feed and/or other substance can be fed at faster or slower rates as desired. It will be appreciated that the rate at which fertilizer, feed and/or other substances are fed can depend on one or more factors, such as, for example, the design of the injector apparatus, the flowrate, velocity, viscosity and other characteristics of the irrigation water or other fluid source, the properties of the feed fluid, the desired dosage rate, the desired irrigation demand and/or the like.

### Priming of Fertilizer Reservoir

With continued reference to FIG. 2, the liquid fertilizer reservoir 120 of the injector apparatus 8 can be placed in hydraulic communication with the fertilizer container 150 via a section of tubing 140. In some embodiments, the tubing 140 is constructed of a flexible and durable material configured to withstand the chemical characteristics of the liquid fertilizer or other chemical being fed into the irrigation water. For example, in some embodiments, the tubing is manufactured from plastic, rubber, silicone, other elastomeric materials and/or the like. The tubing can be advantageously configured to withstand the expected range of negative and/or positive pressure exerted by the fluid itself and/or any external forces. In other embodiments, the tubing is semi-rigid or rigid, such as for example, hard plastic, metal and/or the like.

As illustrated in FIG. 2, the tubing 140 can be connected to the reservoir inlet nozzle 122 on one end and to a corresponding nozzle 158 or other connection on the cap 156 of the fertilizer container 150 on the opposite end. It will be appreciated that a single fertilizer container 150 can be used to feed two or more different injection apparatuses. In one embodiment, the tubing 140 is connected to the apparatus 8 or the container 150 by snugly fitting over the corresponding nozzle. As shown in FIG. 1, a clamp 142 can be used to further secure the tubing 140 to the nozzle.

In FIG. 2, the fertilizer container 150 can comprise a simple plastic bottle. The depicted container 150 includes a handle 152 to facilitate handling and a removable cap 156 to provide easy access to the interior of the container 150. In FIG. 2, the cap can include an outlet nozzle 158 to which tubing 140 or another fluid conduit may attach, a suction nozzle 154 in fluid communication with the outlet nozzle 158 routed within the lower interior portion of the container 150 to access low liquid levels and a squeeze bulb 160 to pressurize the interior of the container 150. As discussed, in some embodiments of its operation, the injector apparatus 8 draws a volume of liquid fertilizer from the liquid fertilizer reservoir 120 and mixes it with the irrigation water or other fluid being delivered (e.g., piped) into the inlet 13. Thus, in order for the apparatus to function properly, an adequate volume of liquid fertilizer in the fertilizer reservoir 120 may be needed. In one embodiment, the volume of liquid fertilizer in the fertilizer reservoir 120 is automatically maintained at a substantially constant level by first priming the system. Two different ways of priming the system are discussed below. However, it will be appreciated that the system may be primed using one or more other methods.

For purposes of the discussion related to priming the fertilizer system, it is assumed that the fertilizer reservoir 120 is initially empty. In one embodiment, the reservoir 120 can be filled by creating a pressure differential between the container 150 and the reservoir 120. Initially, the internal pressure of the container 150 and the reservoir 120 are identical, as both are exposed to atmospheric pressure. However, if the internal pressure of the container 150 is increased sufficiently above the internal pressure of the reservoir, it may be possible to direct liquid fertilizer or any other fluid contained within the container 150 to the reservoir 120 via the tubing 140. For example, in FIG. 2, the container cap 156 includes a squeeze bulb 160 that, when squeezed, generally increases the pressure inside the container 150. Thus, it may be necessary to provide an air tight or a substantially air-tight seal between the container and the cap 156 in order to prevent the air directed into the container 150 from the squeeze bulb 160 from escaping.

The pumping action of the squeeze bulb 160 can pressurize the air volume in the container 150 to a level above the ambient pressure of the reservoir 120. When this pressure differential is sufficiently high, liquid from the container 150 can be forced through the suction nozzle 154, outlet nozzle 158 and tubing 140, and ultimately be discharged into the fertilizer reservoir 120 of the apparatus 8. Liquid from the container 150 may continue to be forced into the tubing 140 and reservoir 120, compressing the air volume downstream of it, until the pressure in the headspace of the reservoir 120 is equal or approximately equal to the pressure in the headspace of the container 150. At this point, the pressure in the headspace of both the reservoir 120 and the container 150 is above the ambient atmospheric pressure. Thus, if the vent button 124 on the reservoir 120 is pressed, pressurized and/or compressed air or other fluid from the reservoir 120 and the tubing 140 may be released, and the pressure within the reservoir 120 will be equilibrated with the ambient atmospheric pressure. Consequently, the pressure within the container 150 exceeds the pressure in the reservoir 120, causing liquid fertilizer to be conveyed to the reservoir 120 via the tubing 140. In one embodiment, once the reservoir 120 has been filled to the fill line 126, the vent button 124 can be released, allowing the pressure in the headspace of the container 150 and the reservoir 120 to equalize. At this point, the system is adequately primed and ready for operation.

In other embodiments, the container 150 may be pressurized using one or more other methods. For example, the container may comprise a hand pump, electric pump, pneumatic pump and/or the like. The hand pump may be manual and/or automatic. In addition, the reservoir 120 may include an air release valve, either in lieu of or in addition to the vent button 124 described in the embodiments disclosed herein.

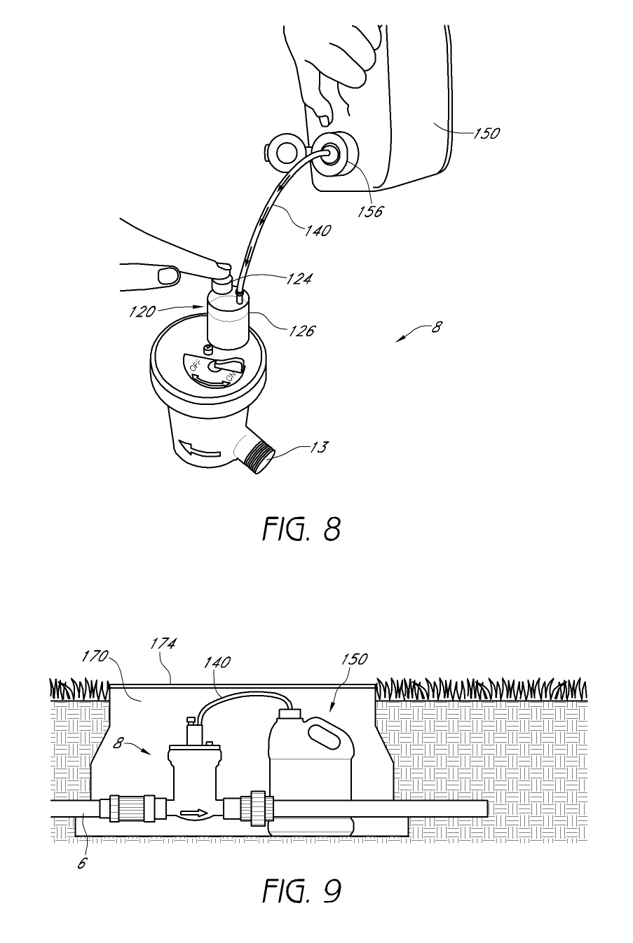

Alternatively, the system may be primed without the need to pressurize the internal space of the container 150. As illustrated in FIG. 8, the system can be primed by lifting the container 150 sufficiently above the reservoir 120, pressing and holding down the vent button 124 of the reservoir 120 and tilting the container 150 so that liquid from the container 150 can exit through the tubing 140. Lifting the container 150 above the reservoir 120 can provide the necessary static head difference to drive the liquid from the container 150 toward the reservoir 120. Similar to the hand pump embodiments described herein, the vent button 124 may be released once liquid fertilizer inside the reservoir 120 has reached the fill level 126.

As described herein, during operation of the fertilizer injector apparatus 8, liquid fertilizer from the liquid fertilizer reservoir 120 may be drawn into a plunger chamber 32. This can lower the pressure in the headspace of the reservoir 120 to below the atmospheric pressure, such that a vacuum or negative pressure results. In some embodiments, this creates a differential pressure between the container 150 and the reservoir 120. The higher pressure in container 150 can cause liquid fertilizer or other fluid to flow from the container 150 to the reservoir 120 of the apparatus 8 so the volume of liquid fertilizer previously drawn into the plunger chamber 32 is replenished. This practice of drawing liquid fertilizer from the reservoir 120 into the plunger chamber 32 and the subsequent replenishment of liquid fertilizer from the container 150 to the reservoir 120 can continue until the liquid fertilizer in the container 150 is exhausted. Once the liquid in the container 150 is exhausted, the container 150 may be refilled or replaced with a new container 150. Further, the system may need to be re-primed as described herein.

In some embodiments, the fertilizer injector apparatus 8 and the liquid fertilizer container 150 with which it is in fluid communication may be positioned immediately next to one another. For example, in the embodiment of FIG. 9, the apparatus 8 and the container 150 are positioned within a single valve box 170. The valve box 170, which may include a cover 174, provides a convenient way to expose a section of a buried irrigation water pipe in order to facilitate installation, servicing and/or maintenance of the fertilizer injector apparatus 8. In addition, this can permit relatively quick and easy access to the container 150 for refilling, priming and/or other purposes. It will be appreciated, however, that the apparatus 8 and/or container 150 may be positioned in any location, either above or below grade and/or close or far away from each other. For example, separate valve boxes or similar structures may be provided for the apparatus 8 and the container 150.

In some embodiments, the injector apparatus can be situated within a valve box or some other below or above grade enclosure. In other embodiments, the injector apparatus can be connected at or near a hose bib or another outlet device. For example, in one embodiment, one or more adapters can be used to connect the inlet of the injector apparatus to a hose bib or other fluid source. In other arrangements, one or more adapters can be used to connect the outlet of the injector apparatus to the hose or other conduit that is used to convey the fluid to one or more desired locations. In yet other embodiments, the injector apparatus can be configured to directly couple to a standard hose bib and/or a hose connection. The injector apparatus can be configured so that it is positioned on the ground, above ground, below ground, hanging or in any other position, as required or desired by the user.

### Dynamic Inlet Nozzle

If the velocity of the water entering the inlet 13 of the fertilizer injector apparatus 8 is sufficiently high, the paddle wheel 36 can be configured to rotate and the apparatus 8 will operate properly as described herein. However, if the water velocity entering the inlet 13 is below a threshold level, it may not be possible to turn the paddle wheel 36 at a desired rotational speed or at all. Consequently, the plunger gear 40 may not turn or may not turn at a sufficient rate, and liquid fertilizer will not be injected into the passing irrigation water. One solution is to increase the velocity of the water that approaches the paddle wheel 36 by decreasing the cross sectional area of the inlet 13. However, this may result in elevated water velocities that may cause the paddle wheel 36 to spin outside its desired range. Further, such excessive rotation of the paddle wheel 36, the plunger gear 40 and/or other mechanically coupled parts can lead to increased bearing wear, vibration and/or other problems which may ultimately interfere with the operation of the apparatus and/or reduce its effective useful life.

In order to eliminate these high velocity problems and to permit the fertilizer injector apparatus 8 to operate at lower flow rates that otherwise would not provide sufficient energy to turn the paddle wheel, a dynamic inlet nozzle 200 may be inserted within the inlet as depicted in FIG. 1. The dynamic inlet nozzle 200 can generally increase the energy in the fluid field at low flow rates, and thus, help achieve a larger inlet flow rate range over which the apparatus 8 will operate. According to basic principles of fluid mechanics, the kinetic energy (KE) imparted by the inlet water is a function of the fluid velocity squared (KE=½mv²; where m is the mass of the fluid and v is the velocity of the fluid). Thus, using a dynamic inlet nozzle 200 or similar device to elevate the velocity of the influent irrigation water or other fluid, increases the kinetic energy imparted on the paddle wheel 36. In turn, this can permit the fertilizer injection aspects of the apparatus 8 to function properly at lower water flow rates.

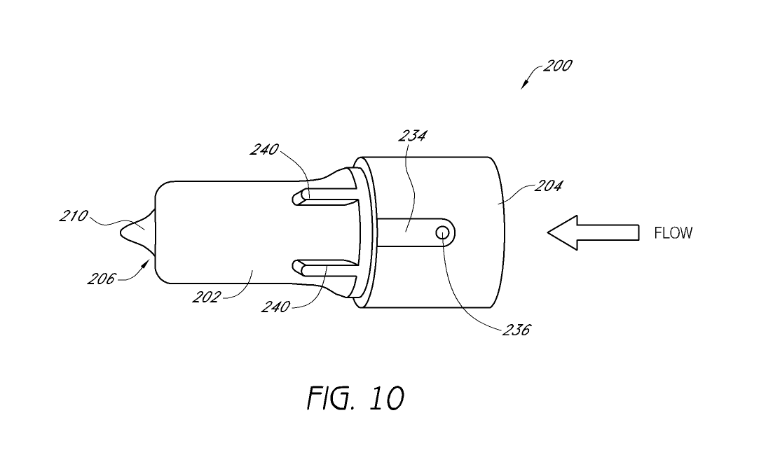

FIG. 10 illustrates one embodiment of the dynamic inlet nozzle 200 configured to be positioned within the inlet 13 of the fertilizer injector apparatus 8. The dynamic inlet nozzle 200 includes a housing 202, a nozzle inlet 204, a nozzle outlet 206 and a restriction member 210. With continued reference to FIG. 10, the dynamic inlet nozzle 200 can also include one or more alignment members 240 and/or recesses 234 along the outside of its housing 202. In some embodiments, the alignment members 240 are configured to slide within corresponding slots in the inlet 13 of the apparatus 13 to ensure proper insertion of the dynamic inlet nozzle 200 within the apparatus 8. As is discussed in greater detail herein, the recess 234 preferably includes one or more openings 236 which are in fluid communication with an interior portion of the dynamic inlet nozzle 200.

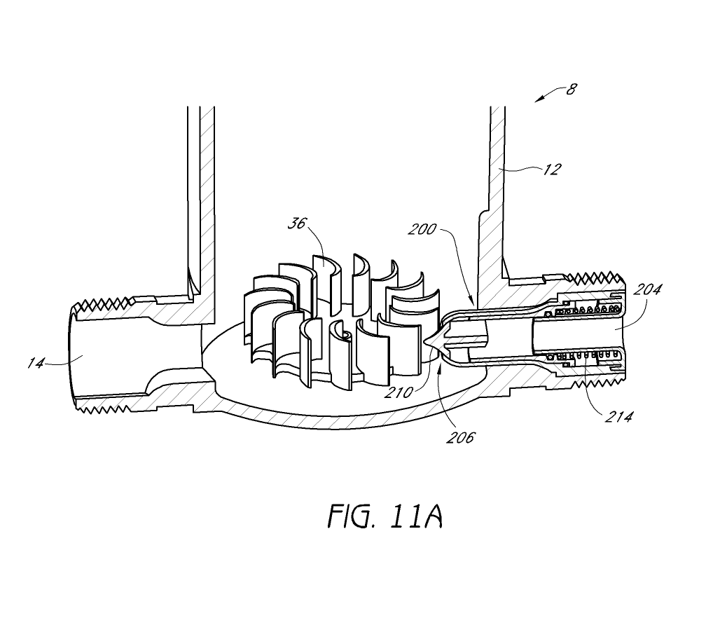

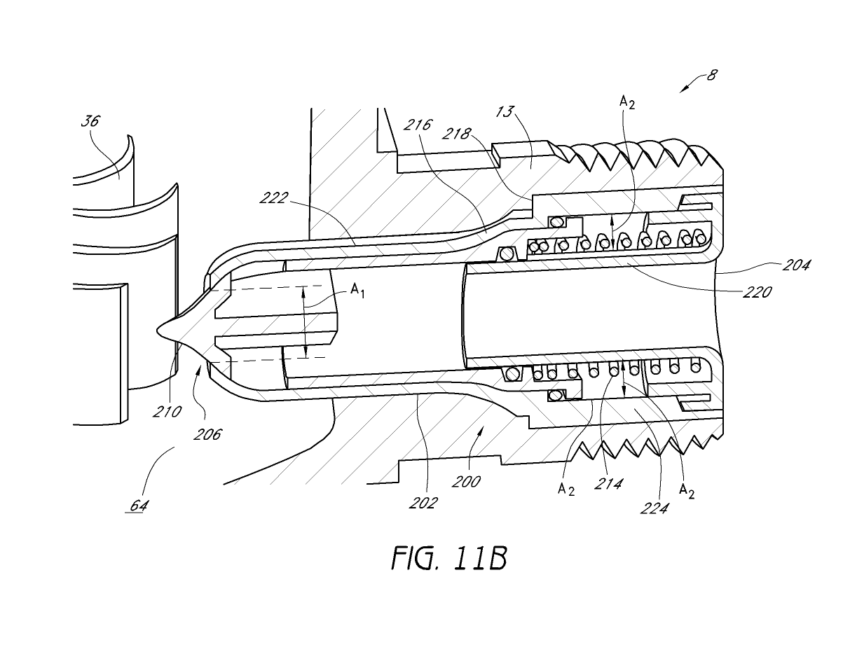

In FIG. 11A, a dynamic inlet nozzle 200 is positioned within an inlet 13 of a fertilizer injector apparatus 8. In the depicted embodiment, there is a relatively tight fit between the outside of the nozzle 200 and the inlet 13. However, the nozzle 200 and/or the inlet 13 may be differently configured in order to provide additional space between these members. As illustrated, the nozzle outlet 206 can be pointed directly at the paddle wheel 36 of the apparatus 8. Therefore, water or other fluid discharged from the nozzle outlet 206 may be directed towards the paddle wheel 36 and cause it to rotate. As described in greater detail herein, rotation of the paddle wheel 36 causes liquid fertilizer stored in the reservoir 120 to be released to the mixing chamber 64 of the injector body 12. Thus, the liquid fertilizer or other substance can be mixed with the irrigation water or other fluid entering the apparatus 8 from the inlet 13 and can be ultimately discharged from the outlet 14.

FIG. 11B provides a detailed view of the dynamic inlet nozzle 200 illustrated in FIG. 11A. In some embodiments, the dynamic inlet nozzle 200 includes a nozzle inlet 204, which, may be flush with the inlet 13 of the apparatus 8. Further, the nozzle inlet 204 can include a cylindrical body 220 that partially extends within the restriction member housing 222, in the direction of the nozzle outlet 206. The restriction member housing 222, which may be attached to the restriction member 210, can be slidably disposed within the nozzle housing 202. This can allow the restriction member housing 202 to horizontally move closer or further away from the nozzle outlet 210 as described below.

The restriction member housing 222 and the restriction member 210 may be molded or otherwise constructed as a single body. Alternatively, the restriction member housing 222 and the restriction member 210 can be separate items that are connected to one another using one or more attachment methods. For example, the restriction member housing 222 and the restriction member 210 can be glued, snap fit, bolted and/or otherwise joined to one another. In one embodiment, the various components of the dynamic inlet nozzle 200, including the nozzle inlet 204, the cylindrical body 220, the restriction member housing 222, the restriction member 210, etc., can be manufactured from one or more durable rigid or semi-rigid materials, such as, for example, plastic, metal and/or the like.

With continued reference to FIG. 11B, an o-ring 216 can be included between the exterior of the cylindrical body 220 and the interior of the restriction member housing 222. In such arrangements, the o-ring 216 can help maintain the water entering the dynamic inlet nozzle 200 within the restriction member housing 222 and the cylindrical body 220. Depending on the differential pressure between the water entering the dynamic inlet nozzle 200 and the water in the mixing chamber 64 of the apparatus 8, the restriction member housing 222 may move toward the nozzle inlet 204. This can create an opening between the restriction member 210 and the nozzle outlet 206 and allow water to exit from the dynamic inlet nozzle 200 into the mixing chamber 64 of the apparatus 8. In the embodiment depicted in FIG. 11B, the restriction member 210 is completely blocking the nozzle outlet 206.

In the embodiment of FIG. 11B, the dynamic inlet nozzle 200 includes a spring 214 around the outside of the cylindrical body 220. The spring 214 (or other resilient member) can be positioned within the interior of the dynamic inlet nozzle 200 to provide a resisting force against the restriction member housing 222 in the direction of the nozzle outlet 206. As illustrated, the spring 214, which is located near the nozzle inlet 204, can abut an end of the restriction member housing 222. It will be appreciated that the resisting force on the restriction member housing 222 may be applied using one or more other methods. Regardless of the type of method used, the spring 214 preferably applies a horizontal force on the restriction member housing 222, urging it against the nozzle outlet 206.

With continued reference to FIG. 11B, the interior of dynamic inlet nozzle 200 can include an infiltration zone 224 which is in fluid communication with the downstream mixing chamber 64 of the apparatus 8. As illustrated in FIG. 10, the dynamic inlet nozzle 200 can comprise one or more recesses 236 that are configured to receive fluid from the mixing chamber 64 when the dynamic inlet nozzle 200 is positioned within the inlet 213 of the apparatus 8. Thus, in some embodiments, fluid entering a recess 236 from the mixing chamber 64 passes through the opening 236 and into the infiltration zone 224. The recesses 236 and the openings 236 are not shown in FIG. 11B. In order to prevent fluid that enters the infiltration zone 224 from escaping to other interior regions of the nozzle 200, one or more o-rings 218 and/or other such members can be included. Since fluid freely enters the infiltration zone 224 through the recesses 236 and openings 236, the pressure of the fluid within infiltration zone 224 is similar or substantially similar to that of the fluid within the mixing chamber 64.

Therefore, the difference in pressure between the fluid in the infiltration zone 224 and the water in the cylindrical body 220/restriction member housing 222 can create a net horizontal force. For example, if the force of the water in the cylindrical body 220/restriction member housing 222 is greater than that in the infiltration zone 224, a net force will result that acts against the infiltration zone 224. Thus, in some arrangements, the force directed in the direction of the nozzle inlet 204 will be generated, opposite of the force created by the spring 214. If this differential pressure force is large enough, it can overcome the resisting force of the spring, causing the restriction member 210 and the restriction member housing 222 to move away from the nozzle outlet 206. Consequently, a corresponding gap can be created between the restriction member 210 and the nozzle outlet 206, permitting water to flow into the mixing chamber 64.

When the water flow rate entering the dynamic inlet nozzle 200 is relatively high, the pressure within the cylindrical body 220/restriction member housing 222 can also be relatively high. As a result, the differential pressure discussed above may also be substantial, causing the spring 214 to be compressed. If the water pressure is sufficiently high, the spring 214 can become substantially or fully compressed, and the gap between the restriction member 210 and the nozzle outlet 206 can be substantially increased or even maximized. Thus, at water flow rates above a particular threshold level, the discharge area of nozzle will remain relatively large or maximized. Accordingly, as the flow rate decreases, the dynamic inlet nozzle 200 can be configured to instantaneously or substantially instantaneously react by automatically changing the position of the restriction member 210 relative to the nozzle outlet 206.

If the flowrate of the irrigation water or other fluid is below a particular threshold level, the force created by the spring 214 can maintain the restriction member 210 against the nozzle outlet, and thus, no water may be permitted to enter the mixing chamber 64. However, if the water flow rate is increased, the differential pressure force can provide a sufficient force to resist the spring force, thereby causing the restriction member 210 to move away from the nozzle outlet 206. If the flow rate is only slightly above the level that causes the restriction member 210 to move away from the nozzle outlet 206, the size of the discharge area created may be relatively small. Therefore, the velocity of the water exiting the dynamic nozzle outlet 206 can be relatively high, as fluid velocity is inversely proportional to area (Q=VA; where Q=flow rate, V is fluid velocity and A is area). Thus, a smaller discharge area may increase the velocity of the water to cause the paddle wheel 36 to turn. In contrast, if the discharge area at the inlet 13 of the apparatus 8 is fixed and unable to respond to changes in the water flow rate, it may be difficult to obtain a sufficiently high discharge velocity to cause the paddle wheel 36 to adequately rotate, especially at low flow rates.

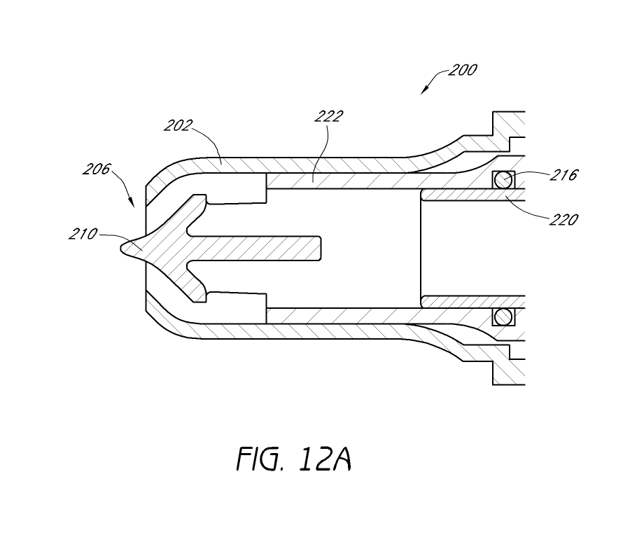

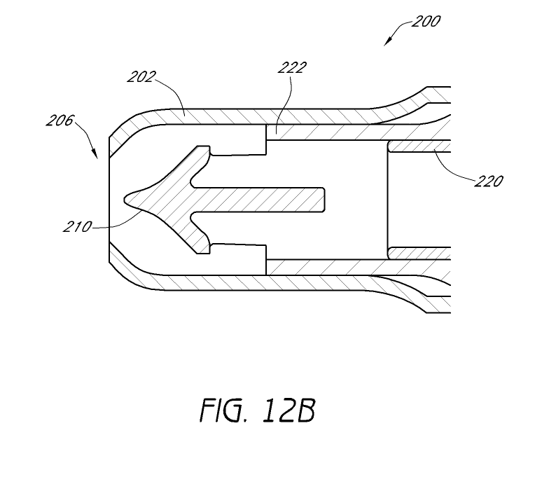

FIGS. 12A and 12B illustrate the restriction member 210 of the dynamic inlet nozzle 200 at different positions relative to the nozzle outlet 206 in response to a varying water flow rate. In the embodiment depicted in FIG. 12A, the restriction member 210 is partially retracted from the nozzle outlet 206. In FIG. 12B, the restriction member 210 is fully retracted from the nozzle outlet 206, thereby generally increasing or maximizing the total discharge area.

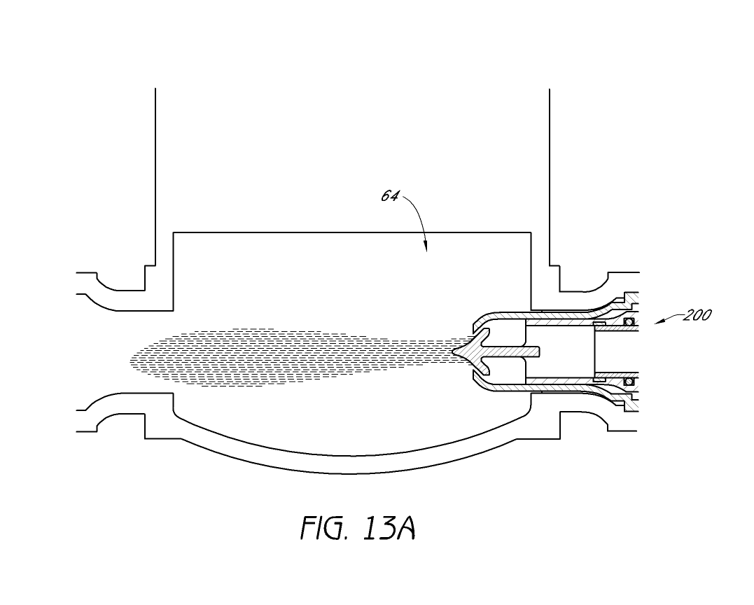

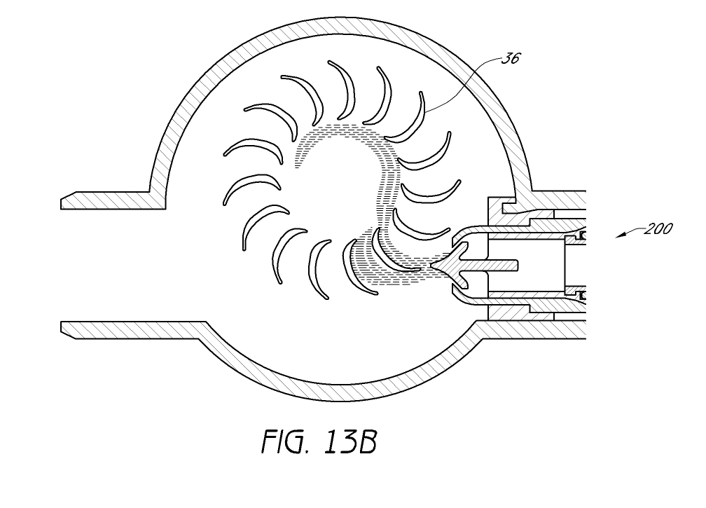

FIG. 13A illustrates a computer-generated model of a flow field created by one embodiment of a dynamic inlet nozzle. The depicted flow field, which was generated for a relatively low water flow rate, is substantially horizontal and capable of reaching the outlet 14 of the apparatus 8. The flow field representation is provided to merely illustrate the effect of providing a reduced discharge area using a dynamic inlet nozzle. Further, FIG. 13B illustrates a high velocity, low flow rate flow field (similar to the one in FIG. 13A), and its effect on a paddle wheel 36.

In one embodiment, a dynamic inlet nozzle 200 may include a spring 214 having an adjustable spring coefficient. This can enable a user to further customize the fertilizer injector apparatus 8 according to particular operating conditions, such as, for example, the minimum differential pressure across the dynamic inlet nozzle 200 that will cause the restriction member 210 to move away from the nozzle outlet 206. For instance, the user may want to inject a greater volume of liquid fertilizer into the irrigation water at lower flow rates. In such a situation, the user may be able to increase the spring coefficient (making the spring stiffer). This can provide a smaller discharge area, and thus a higher velocity for the water exiting the nozzle outlet 206. In turn, the increased water velocity can increase the rotation rate of the paddle wheel causing a higher volume of liquid fertilizer to be directed into the mixing chamber 64 from the reservoir 120.

In some embodiments, the restriction member 210 of the dynamic inlet nozzle 200 is configured to allow flow to discharge through the nozzle outlet 206 when a minimum differential pressure between the inlet and outlet ends exists. By way of example, when the differential pressure reaches approximately 10 pounds per square inch (psi), the restriction member 210 can move away from the outlet 206. This can allow fluid flow through the nozzle outlet 206. The minimum differential pressure required to move the restriction member 210 away from the nozzle outlet 206 can be higher or lower than 10 psi, as desired or required by a particular application.

Once discharged from the dynamic inlet nozzle 200, water or other liquid can flow into the downstream irrigation piping or other hydraulic system. The flow and pressure in the downstream piping system can depend on one or more factors, such as, for example, the flowrate demand required by the different irrigation system outlets (e.g., sprinkler heads, sprays, drip systems, etc.), the diameter, length and other characteristics of the piping system conveying the liquid and/or the like. Consequently, the pressure at the discharge end of the dynamic inlet nozzle 200 may depend, at least in part, on the type of irrigation fixtures being used and other features of the irrigation piping. For example, if a small volume of water is being discharged from the irrigation system (e.g., as in a drip irrigation system), the pressure immediately downstream of the dynamic inlet nozzle 200 can remain relatively high. Alternatively, if the irrigation demand is relatively high, as is the case, for example, with a system that includes a plurality of sprinklers, the pressure immediately downstream of the dynamic inlet nozzle 200 may be lower.

In some embodiments, the restriction member 210 can automatically move relative to the nozzle outlet 206 to maintain a substantially constant differential pressure across the nozzle 200. For example, as the flowrate demand downstream of the dynamic nozzle decreases, the restriction member 210 can move closer to the nozzle outlet 206, effectively decreasing the cross-sectional area through which the irrigation water or other liquid discharges. Low downstream demands can be found in irrigation systems having low-flow discharge fixtures, such as, for example, drip irrigation emitters, low-flow sprinlders and the like. However, if the demand decreases below a particular minimum threshold level, the restriction member 210 may completely or substantially completely seat against the nozzle outlet 206, thereby preventing or severely restricting liquid flow through the dynamic inlet nozzle 200. In one embodiment, a downstream demand rate of approximately 0.7 gallons per minutes (gpm) or lower can cause flow through the dynamic inlet nozzle 200 to cease. In other embodiments, this threshold minimum flowrate can be lower or higher than 0.7 gpm.

The dynamic inlet nozzle 200 can be configured so that the irrigation water or other fluid can be directed through the nozzle 200 even at very low downstream flowrate demands. In such situations, the cross-sectional area of the nozzle outlet 206 through which the water is being transmitted can be relatively small. Thus, since velocity and cross sectional area are inversely related (V=Q/A; where Q is flowrate, V is velocity and A is cross-sectional area), the velocity through the outlet 206 of the inlet dynamic nozzle 200 can be maintained sufficiently high to permit the discharged liquid to contact the paddle wheel 36. As discussed herein, if the liquid contacts the paddle wheel 36 with sufficient energy, the paddle wheel 36 can rotate, permitting liquid fertilizer to be injected into the irrigation water from the reservoir 120.

As the downstream water demand increases, the restriction member 210 can retract away from the nozzle outlet 206 in an effort to maintain a substantially constant pressure loss across the dynamic inlet nozzle 200. If the flowrate through the nozzle 200 exceeds a particular level, the restriction member 210 can fully retract within the nozzle housing. If the flowrate through the nozzle 200 continues to increase, the differential pressure across the nozzle 200 can also increase, because the restriction member 210 cannot retract further to maintain a substantially constant differential pressure.

As discussed, at higher downstream flowrates, the effective cross-sectional area at the nozzle outlet 206 can increase. Thus, the velocity of the irrigation water discharged through the nozzle 200 can decrease to help prevent damage to the paddle wheel 36 or other components of the apparatus due to excessive discharge velocities. Consequently, the dynamic inlet nozzle 200 can help maintain the velocity of the discharged irrigation water or other liquid within a desired range, even at relatively low flowrates.

The following are examples of force balance calculations for one embodiment of the dynamic inlet nozzle 200. For purposes of the following example, the effective cross sectional area (A₂) which defines the annular-shaped interface between the infiltration zone 224 and the adjacent portion of the nozzle 200 is approximately 0.3632 square inches (in²). It will be recognized that the effective cross-sectional area of the downstream portion of the restriction member 210 on which the differential force acts may vary depending on the horizontal position of the restriction member 210. However, in this embodiment, the effective cross-sectional area (A₁) is approximately 0.0707 in² when the restriction member 210 is urged against the nozzle outlet 206.

Those of skill in the art will appreciate that the spring coefficient, the length of the spring 214, the extent to which the spring 214 is or may be compressed within the nozzle 200, the dimensions of the restriction member 210, nozzle outlet 206 or other components of the dynamic inlet nozzle 200 and/or other properties or characteristics of the dynamic inlet nozzle 200 may be different than indicated in this example.

### EXAMPLE

In one embodiment, the differential pressure (ΔP) across the dynamic inlet nozzle 200 during the dynamic range is desirably approximately 10 pounds per square inch (psi). Thus, if the drag force on the o-ring is ignored, when the nozzle 200 is fully closed, i.e., the restriction member 210 is urged against the nozzle outlet 206, the necessary spring force (F_{S}) is approximately 2.9 lbs.

F_{S}+(ΔP*A₁)=(ΔP*A₂)

F_{S}=ΔP*(A₂−A₁)

F_{S}=10 psi *(0.3632−0.0707 in²)=2.9 lbs

In this embodiment, the spring 214 in the dynamic inlet nozzle has a spring coefficient (k) of 1.6 pounds per inch (lbs/in). In addition, the uncompressed length of the spring 214 is 2.512 inches. In the embodiment used for this example, the spring 214 is approximately 1.812 inches long when the restriction member 210 is fully urged against the nozzle outlet 206. Further, the spring 214 is approximately 2.062 inches long when the restriction member 210 is furthest from the nozzle outlet 206 (the discharge area of the dynamic inlet nozzle 200 is maximized). Thus, in this embodiment, the restriction member 210 is capable of moving a total of approximately 0.25 inches within the nozzle 200. Further, when the nozzle 200 is fully closed (0.000 inch stroke), as shown in FIGS. 11A and 11B, the approximate ΔP at which the restriction member 210 will begin to move away from the nozzle outlet 206 is 9.92 psi.

F_{S}=kx; where x is the compressed length of the spring

Fₛ=(1.6 lbs/in)*(2.512−0.700 in)=2.9 lbs

Force Balance Equation: Fₛ=ΔP*(A₂−A₁)

ΔP=F_{S}/(A₂−A₁)=2.9 lbs/(0.3632−0.0707 in)=9.92 psi

When the nozzle 200 is approximately half open (e.g., about 0.125 inch stroke), as illustrated in FIG. 12A, A₁ is approximately 0.0240 in². Thus, the approximate ΔP across the dynamic inlet nozzle 200 is 9.14 psi.

Fₛ=kx=(1.6 lbs/in)*(2.512−0.700+0.125 in)=3.1 lbs

ΔP=F_{S}/(A₂−A₁)=3.1 lbs /(0.3632−0.0240 in)=9.14 psi

When the nozzle 200 is approximately fully open (e.g., 0.250 inch stroke), as illustrated in FIG. 12B, A₁ is approximately 0.0047 in². Thus, the approximate ΔP across the dynamic inlet nozzle 200 is 9.21 psi.

FS=kx=(1.6 lbs/in)*(2.512−0.700+0.250 in)=3.3 lbs

ΔP=F_{S}/(A₂−A₁)=3.3 lbs/(0.3632−0.0047 in)=9.21 psi

The basic principles of the dynamic inlet nozzle can be applied to one or more other technologies where it is desirable to increase the velocity of a fluid, especially one flowing at relatively low flowrates. For example, the dynamic nozzle can be incorporated into a turbocharger or other forced induction system for internal combustion engines, turbines and the like. In one embodiment, the dynamic nozzle can be used to increase the rotational speed of a downstream turbine when engine exhaust flowrates are relatively low. For example, exhaust flow can be directed from the engine, through the dynamic nozzle, and onto the turbine to drive the rotation of the turbine. Preferably, the turbine can be coupled to an air compressor or pump, and can operate the compressor to direct compressed air into the cylinders of the engine through the air intake valves of the cylinders. Incorporation of such dynamic nozzles can eliminate or reduce the effects of “turbo lag”, which can include the time it takes for the exhaust flow to build to a sufficiently high level so as to power the turbo turbine of the turbocharger or other similar device.

As used herein, the term “fluid” is a broad term and is used in accordance with its ordinary meaning and may include, without limitation, liquids, gases, plasmas, plastic solids, gels, thixotropic fluids, non-Newtonian fluids and/or combinations thereof.

Various embodiments of the dynamic inlet nozzle can also be used to regulate the pressure drop across a section of a pipe or other hydraulic system. In other embodiments, dynamic nozzles can be used to maintain discharge flowrate above and/or below certain desired threshold levels.

### Quick-Connect Fitting

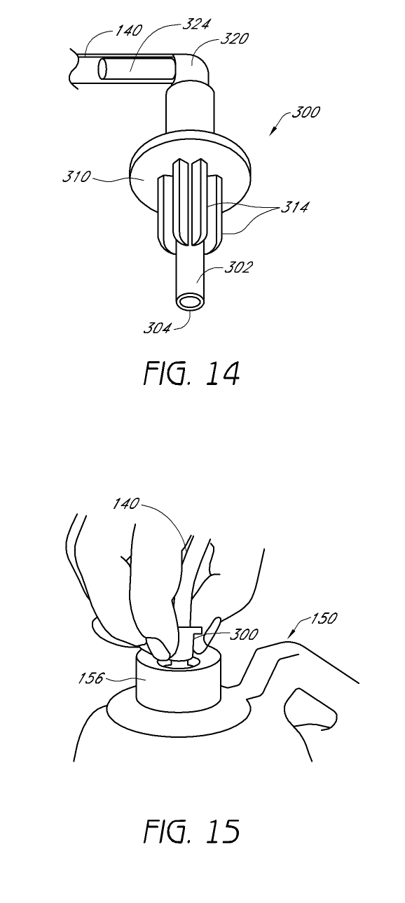

FIGS. 14 and 15 illustrate a quick-connect fitting 300 configured to connect to the cap 156 of a liquid fertilizer container 150 (e.g., bottle). As shown in FIG. 14, the opposite end of the quick-connect fitting 300 can be attached to tubing 140 or another conduit. In one embodiment, the tubing 140 is in fluid communication with the reservoir 120 of a fertilizer injector apparatus 8 as described above. However, the quick-connect fitting 300 can be used in one or more other applications, and its uses should not be restricted to liquid fertilizer systems.

With reference to FIG. 14, the quick-connect fitting 300 can include a cylindrical and hollow protrusion member 302 which may be sized, shaped and otherwise configured to be positioned within a corresponding opening in the container 150 (e.g., cap, fitting, etc.). It will be appreciated that the protrusion member 302 may have a shape other that cylindrical to match a corresponding opening in a container. The opening 304 within the protrusion member 302 may be protected with a screen, filter and/or any other member (not shown) to prevent particulates and other unwanted substances from entering the interior of the quick-connect fitting 300.

In some embodiments, the quick-connect fitting 300 includes an enlarged disc member 310 or other engagement member that can function as a stop to indicate to a user that the protrusion member 302 has been adequately positioned within the container opening. In one embodiment, the cap 156 includes a recess (not shown) in which the disc member 310 or other engagement member can be situated when the quick-connect fitting 300 is properly connected to the container 150. A gasket or other sealing member positioned on the bottom of the disc member 310 and/or the top of such a recess may be used to provide additional protection against leaks.

The quick-connect fitting 300 can include one or more tabs 314 or alignment features around the protrusion member 302. The tabs 314 can be used to properly align the quick-connect fitting 300 within the corresponding opening of the container. In addition, the tabs can improve the sealing characteristics between the quick-connect fitting 300 and the container opening. The quick-connect fitting 300 can also comprise a discharge nozzle 324 over which tubing 140 or another conduit may slide. In the embodiment illustrated in FIG. 14, the quick-connect fitting 300 includes a 90 degree bend at its discharge end. It will be appreciated that the exact size, angle, shape, general arrangement and other characteristics of the quick-connect fitting 300 are not important, and thus, may be different than shown in FIG. 14 and described herein.

FIG. 15 illustrates a user connecting a quick-connect fitting 300 to the cap 156 of a container 150. In one embodiment, to connect a quick-connect fitting 300 to a container, a user simply pushes the quick-connect fitting 300 into a corresponding opening in the cap 156 or other portion of a container 150. The quick-connect fitting 300 can optionally include a positive engagement member on the protrusion 302 and/or other location that notifies the user that the quick-connect fitting 300 has been inserted to a desired or proper depth. For example, the engagement member can produce an audible clicking sound when the desired or required depth has been attained. When the user wishes to disconnect the quick-connect fitting 300 from the container 150, he or she may simply reverse the process by pulling the quick-connect fitting 300 away from the cap 156 or other opening in the container 150.

The quick-connect fitting 300 can be constructed of one or more rigid or semi-rigid materials, such as, for example, plastic, metal, other composite materials and/or the like. As discussed, the quick-connect fitting 300 can include a rubber gasket or other sealing device to provide a leak-proof or substantially leak-proof connection with the container 150. In other embodiments, additional leak-proof and/or positive engagement members can be provided. For example, the protrusion and the corresponding opening of the cap 156 may be provided with matching threads or other features.

Although the quick-connect fitting 300 has been discussed in relation to connecting to a container 150, it will appreciated that similar quick-connect fittings may be used to connect to other openings, such as, for example, the reservoir 120 of the fertilizer injection apparatus 8. In some embodiments, the quick-connect fitting 300 and the connection between the cap 156 and the container 150 is generally air-tight to maintain an increased headspace pressure in the container 150. Such an air-tight connection may, for example, facilitate priming of the fertilizer apparatus 8 as discussed above.

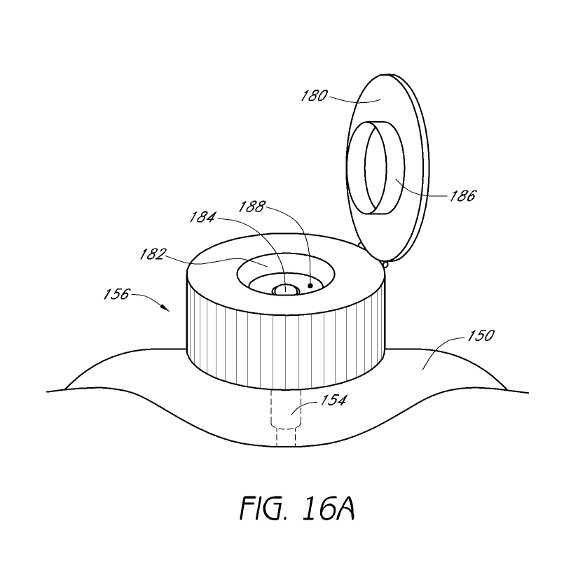

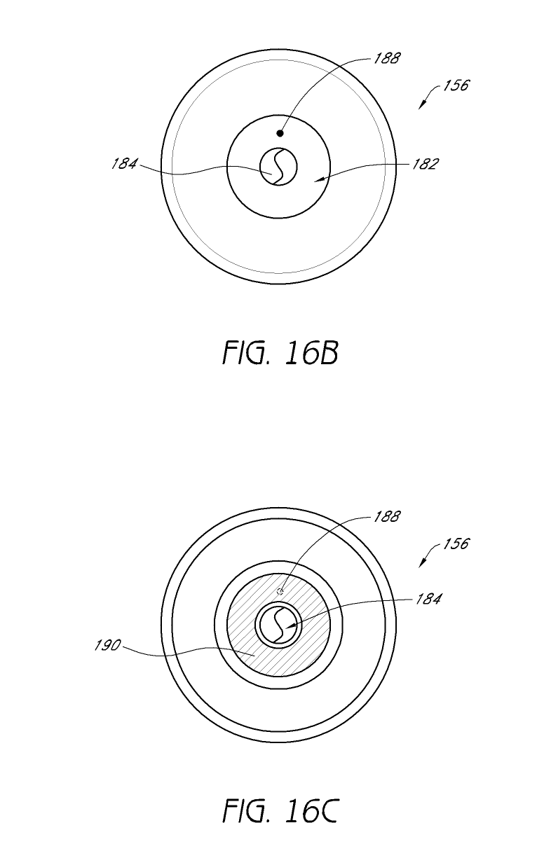

FIG. 16A illustrates one embodiment of a cap 156 configured for placement on an opening of a container 150. In the depicted embodiment, the cap 156 is attached to the container 150 using a threaded connection. Alternatively, the cap 156 may be snap fit or otherwise attached to the container 150. The cap 156 can include a lid 180 or other closure member to prevent access to the cap opening 184. In FIG. 16A, the lid 180 is hingedly connected to the cap 156. However, the lid or other closure member may be connected to the cap 156 using one or more other methods. Further, in some embodiments, the lid 180 need not be connected to the cap 156.

With continued reference to FIG. 16A, the cap 156 can include a recess area 182 along its top surface. As illustrated, the lid 180 may include a corresponding annular member 186 that is configured to fit within the recess area 182 when the lid 180 is closed. A cap opening 184 that is preferably in fluid communication with the inside of the container 150 may be positioned within the recess area 182. In the embodiments illustrated in FIGS. 16A and 16B, the cap opening 184 comprises a circular shape and is positioned near the center of the recess area 182. The recess area 182 can also include one or more vent openings 188 that also are in fluid communication with the inside of the container 150.

FIG. 16C is a bottom view of the cap 156 shown in FIG. 16A. In the illustrated embodiment, a sealing member 190 is positioned around the cap opening 184. Further, the sealing member 190, which has an annular shape, can be snugly positioned around the cap opening 184. For example, if the cap 156 is connected to a suction nozzle 154 (FIGS. 2 and 16A), the sealing member 190 can be positioned around the outer diameter of the suction nozzle 154. The sealing member 190 can comprise one or more rubber, silicone and/or any other elastic or semi-elastic materials. In addition, it will be appreciated that two or more sealing members can be included in a single cap 156.

With continued reference to FIG. 16C, the sealing member 190 is configured to completely or substantially completely cover the vent opening 188 when the sealing member 190 is urged against the undersurface of the cap 156. Typically, the vent opening 188 can facilitate flow out of the container 150 by allowing air to enter the container 150 to replace the volume of liquid discharged. Therefore, in some embodiments, when the sealing member 190 is positioned against the undersurface of the cap 156, the vent opening 188 does not permit air to enter as the container 150 is being emptied.

If a container 120 includes a cap 156 comprising a sealing member 190, as is discussed in relation to some of the embodiments described and/or illustrated herein, the sealing member 190 can block the vent opening 188. Consequently, liquid fertilizer or any other fluid stored within the container 150 will be prevented from generally leaking through the vent opening 188 of the cap 156. Such leak prevention may be useful when the container 150 is tilted in such a way that its liquid contents would otherwise be allowed to leak through the vent opening 188. For example, as discussed, the injection apparatus described herein may be primed by tilting the container 150 so that liquid flows into the fluid reservoir 120. The static pressure of the liquid fertilizer or other liquid contained within the container 150 can help urge the sealing member 190 against the underside of the cap 156. When the container 150 is returned to its normal upright position, the liquid contents of the container 150 will no longer exert a sealing pressure on the sealing member 190. Thus, the sealing member 190 can move sufficiently away from the cap 156 to permit air to enter the container, thereby replenishing the volume of liquid discharged. This can facilitate re-priming of the system by eliminating the vacuum created within the tank during the prior priming procedure.

In addition, in some embodiments, the sealing member 190 can block the vent opening 188 when pressure of the headspace within the container 150 is sufficiently increased, as is discussed herein in relation to another priming method. If the pressure inside the container 150 is sufficiently high, the sealing member 190 can be urged against the underside of the cap 156. This can help maintain the internal pressure of the container so that the desired volume of liquid can be transferred from the container 150 to another device, such as, for example, the injection apparatus 8.

The skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. Additionally, the methods which is described and illustrated herein is not limited to the exact sequence of acts described, nor is it necessarily limited to the practice of all of the acts set forth. Other sequences of events or acts, or less than all of the events, or simultaneous occurrence of the events, may be utilized in practicing the embodiments of the inventions.

Although the inventions herein have been disclosed in the context of certain embodiments and examples, it will be understood by those skilled in the art that the inventions extend beyond the specifically disclosed embodiments to other alternative embodiments and/or uses and obvious modifications and equivalents thereof. Accordingly, the inventions are not intended to be limited by the specific disclosures of preferred embodiments herein.

What is claimed is:

1. An apparatus for injecting a first fluid into an irrigation conduit carrying a second fluid, said apparatus comprising:
an inlet and an outlet, said inlet and outlet configured to be connected to an irrigation conduit;
at least one mixing chamber, said mixing chamber in fluid communication with the inlet and outlet; and
a fluid reservoir in one-way fluid communication with the mixing chamber, said fluid reservoir comprising:
a reservoir inlet;
a reservoir outlet; and
a vent member;
wherein a second fluid flowing through the inlet causes a volume of a first fluid to enter into the mixing chamber through the reservoir outlet.

2. The apparatus of claim 1, further comprising a paddle wheel generally positioned within the mixing chamber, wherein the amount of a volume of the first fluid depends that enters the mixing zone depends on the rotational speed of the paddle wheel.

3. The apparatus of claim 1, wherein the vent member comprises a button.

4. The apparatus of claim 1, further comprising:
a plunger chamber in fluid communication with the reservoir outlet and the mixing chamber;
a plunger movably disposed within the plunger chamber; and
at least one plunger gear configured to rotate when the paddle wheel rotates;
wherein rotation of the plunger gear causes a movement of the plunger in a first direction within the plunger chamber, said movement in the first direction being configured to permit a volume of the first fluid to enter the plunger chamber from the fluid reservoir; and
wherein further rotation of the plunger gear causes a movement of the plunger in a second direction within the plunger chamber, said movement in the second direction allowing the volume of the first fluid within the plunger chamber to flow into the mixing chamber.

5. The apparatus of claim 1, the apparatus further comprising:
a nozzle configured to be removably positioned within the inlet, said nozzle comprising:
a housing comprising a nozzle inlet, a nozzle outlet and a fluid passageway positioned between said nozzle inlet and said nozzle outlet;
a restriction member slidably disposed within the housing, said restriction member configured to substantially block the nozzle outlet when oriented in a first position;
a biasing member configured to exert a force on the restriction member in a direction of the first position; and
an infiltration zone in fluid communication with the mixing zone;
wherein the restriction member is configured to slide within the housing in response to a pressure differential between a fluid pressure in the mixing zone and a fluid pressure within the fluid passageway.

6. An inlet nozzle configured to be positioned within an inlet of a fluid device, said inlet nozzle comprising:
a housing comprising:
a nozzle inlet;
a nozzle outlet in fluid communication with an interior area of a fluid device; and
a fluid passageway positioned between the nozzle inlet and the nozzle outlet;
a restriction member slidably disposed within the housing, said restriction member configured to substantially block the nozzle outlet when oriented in a first position;
a biasing member configured to exert a force on the restriction member in a direction of the first position; and
an infiltration zone in fluid communication with the interior area of the fluid device;
wherein the restriction member is configured to slide within the housing in response to a pressure differential between a fluid pressure in the area of the fluid device and a fluid pressure within the fluid passageway.

7. The inlet nozzle of claim 6, wherein the biasing member is a spring.

8. The inlet nozzle of claim 6, further comprising an o-ring, said o-ring positioned between the fluid passageway and the infiltration zone, and said o-ring being configured to substantially prevent fluid communication between the fluid passageway and the infiltration zone.

9. A coupling for connecting a fluid line to a container, said coupling comprising:
a fitting comprising:
a protrusion member configured to be positioned within a container opening;
an engagement member configured to contact a surface of a container; and
at least one tab positioned along an outside surface of the protrusion member; and
a container portion comprising an opening configured to receive the protrusion member and at least one recess configured to receive the at least one tab of the fitting;
wherein insertion of the protrusion member within the container opening creates a substantially leak-tight connection between the fitting and the container.

10. The coupling of claim 9, further comprising at least one sealing member generally positioned between the fitting and the container portion.

11. The coupling of claim 10, wherein the sealing member comprises a gasket.

12. The coupling of claim 9, wherein the container portion comprises a bottle cap.

13. The coupling of claim 9, wherein an interior of the container is maintained in a substantially air-tight condition when the coupling is connected to said container.

14. A system for injecting a first liquid into an injection apparatus, said system comprising.
an injection apparatus comprising:
an inlet and an outlet, said inlet and outlet configured to be connected to an irrigation conduit configured to channel a second liquid;
at least one mixing chamber, said mixing chamber in fluid communication with the inlet and outlet; and
a fluid reservoir in one-way fluid communication with the mixing chamber;
a container configured to hold the first liquid; and
a connecting conduit in fluid communication with the container and the fluid reservoir;
wherein the first fluid is directed from the container to the fluid reservoir and into the mixing chamber to be mixed with the second liquid.
